(19) United States
(12) Patent Application Publication
(10) Pub. No.: US 2025/0383867 A1
(43) Pub. Date: Dec. 18, 2025

(54) META VERSIONING OF MULTI-SOURCE ARTIFACTS

(71) Applicants: Constructor Technology AG, Schaffhausen (CH); Constructor Education and Research Genossenschaft, Schaffhausen (CH)

(72) Inventors: Alexey Koryakin, Zurich (CH); Alexander Tormasov, Kazan (RU); Serg Bell, Costa del Sol (SG); Stanislav Protasov, Singapore (SG); Nikolay Dobrovolskiy, Istanbul (TR); Laurent Dedenis, Singapore (SG)

(21) Appl. No.: 18/745,290

(22) Filed: Jun. 17, 2024

(51) Int. Cl. G06F 8/71; G06F 16/27

(52) U.S. Cl. CPC G06F 8/71; G06F 16/27

(57) ABSTRACT

Systems and methods for verification of a result of execution of a computational system, including generating the result by executing elements of a computational system by a developer party, saving the result in a computer storage, preserving a current state of elements of the computational system by creating a meta-version label in a meta-version tracking system for the meta-version of the computational system and linking the elements of the computational system to the meta-version label, sending to the meta-version tracking system a request to verify the result of the computational system by a verifying party, recreating and deploying elements of the computational system by transferring information to an external device, generating a verification result, and comparing the verification result to the result previously generated.

### TECHNICAL FIELD

The present disclosure relates generally to information systems, and more particularly, meta-versioning of multi-source artifacts.

### BACKGROUND

There is a great demand to cooperate between different entities such as groups of scientists, research institutes, universities, R&D laboratories, and corporations.

Modern information systems contain two major types of sources that can be created, accessed for reading, and in some cases—updated, deleted or otherwise destroyed. These are data and programs. Often, large data sources—automatically generated by sensors or other machinery—are analyzed by a group of researchers that receive results either by processing these data with computer generated code or by other means. Examples of such databases are petabyte-level proteins and genomes.

At present, sometimes one or more generated data sources need to be verified with several different information systems already developed by one or more different entities that already worked on generation and analysis of these sources. In both cases, there is a need to share a certain version of these data and source code with another group of scientists, developers, or researchers. In general, objects comprising digital data and metadata stored in different media such as files, databases, different memory segments, custom objects, mobile devices, smart cards, or cryptographic processors may need to be shared between groups of operators, and there is a need to preserve a state of these data and metadata at a certain point in time, either arbitrary or determined by a certain event of achievement of certain conditions, for example, a release of a software program.

In general, current systems suffer from two main aspects. The first aspect is related to the independent verification for one entity of the results obtained by another entity. The second aspect is related to the productization of complex information systems that contain one or more sources of data, as well as source code potentially under development by different organizations. In particular, different parts of such complex systems are changing almost independently from each other: when one group of researchers started working with one version of the data and software, another group of scientists already updated the data source with additional results and changed its software.

Therefore, there is a need for a system that can cohesively accumulate the information about the stable states of different data sources and software programs that are known to work together.

### SUMMARY

Aspects of the disclosure relate to the field of versioning and verification of results related to execution of complex computational programs based on a large amount of computational data, more specifically to systems and methods for improving the quality of the preservation process of a state associated with a version of data and meta-data. A method of the present disclosure overcomes the shortcomings of the existing approaches by performing the verification of the result of execution of a computational system CS implementing the versioning process in a meta-version tracking system MVTS. Embodiments operate with three types of sources: persistent, the ones that do not change over a period of time between the creation of a version and generation of the verification result; non-persistent with version tracking capabilities, and non-persistent without version tracking capabilities.

Embodiments therefore provide an opportunity for one entity to independently verify the results obtained by another entity. Embodiments further productize a complex information system that contains one or more large sources of data, as well as source code potentially under development by different organizations.

Hence, embodiments overcome the aforementioned shortcomings of existing solutions, use minimal storage space, and improve the quality and the speed of verification of a result obtained by the execution of a computational system using different sets of data.

Systems and methods classify data and software development sources and provides a way to create a “hyper-” or “meta-” version of a collection of different objects which versions are tracked independently thus giving a snapshot of an entire amalgamated system, specifically, allowing to identify collections of stable versions of different parts of the system.

In one example, a method is implemented in a system comprising a result generator, a meta-version data collection system and a deployment module, the method comprising: generating a result R by executing elements of a computational system CS by a developer party DP, saving the result R in a computer storage ST₁, preserving a current state of elements of the computational system CS by creating a meta-version label MVL in a meta-version tracking system MVTS for a meta-version of the computational system CS and linking the elements of the computational system CS to the meta-version label, sending to the meta-version tracking system MVTS a request to verify the result of the computational system CS by a verifying party VP, recreating and deploying elements of the computational system CS by transferring information to a storage device, generating a verification result VR, and comparing the verification result VR to the result R previously generated.

In an embodiment, a method of verification, by a verifying party (VP), of a result (R) of execution of a computational system (CS), which comprises computational system elements including a computational program (CP) comprising a script or binary code, computational data (CD) comprising structured data records stored on a hard drive as one or more files or any other part of a computer memory and accessible through an interface, and a computational environment (CE) comprising one or more physical or virtual computers, operating systems, libraries, or runtime environments comprises A. generating, by a developer party (DP), the result (R) by executing the computational program (CP) using the computational data (CD) within the computational environment (CE); B. saving, by the developer party (DP), the result (R) in a first computer storage (ST₁); C. creating, by a meta-version tracking system (MVTS) comprising a meta-version database (MVD), a meta-version label (MVL) including information associated to a current state of the computational system (CS) and performing, by the meta-version tracking system (MVTS), the following sub-operations in any order: C1. when one or more elements of the computational systems (CS) are one or more respective non-persistent elements (EL₁), creating respective copies, on the meta-version database (MVD), of the respective non-persistent elements, and saving, on the meta-version database (MVD), respective first information records indicating respective relationships between the one or more respective non-persistent elements (EL₁) and the meta-version label (MVL), C2. when one or more elements of the computational systems (CS) are one or more respective persistent elements (EL₂), saving respective second information records indicating respective relationships between the one or more respective persistent elements (EL₂) and the meta-version label (MVL) and an address and authentication information of a storage containing the one or more respective persistent elements (EL₂), C3. when one or more elements of the computational systems (CS) are one or more respective version-controlled elements (EL₃), saving in the meta-version database (MVD) respective third information records indicating respective relationships between the one or more respective version-controlled elements (EL₃) and the meta-version label (MVL) and an address and authentication information of a storage containing the one or more respective version-controlled elements (EL₃), wherein at least one of the elements of the computational systems (CS) is non-persistent or non-version controlled; D. obtaining, by the verifying party (VP) from the meta-version tracking system (MVTS), the meta-version label (MVL); E. recreating, by the verifying party (VP), the current state of the computational system (CS) by performing the following sub-operations: E1. in any order, transferring from the meta-version database (MVD) and from at least one external storage, on the basis of said first, second, and third information records: the copy of the one or more non-persistent elements (EL₁), relationships with the one or more persistent elements (EL₂), and relationships with the one or more version-controlled elements (EL₃), E2. providing a deployed and configured computational environment (VCE), a deployed and configured computational program (VCP) and a deployed and configured computational data (VCD) by using the elements transferred in sub-operation E1; F. generating, by the verifying party (VP), a verification result (VR) by executing the deployed and configured computational program (VCP) using the deployed and configured computational data (VCD) within the deployed and configured computational environment (VCE) provided in sub-operation E2; and G. saving, by the verifying party (VP), the verification result (VR) in a second computer storage (ST₂).

In an embodiment, a system for verification of a result (R) of execution of a computational system (CS) comprising elements of the computational system (CS) which include a computational program (CP), computational data (CD) and a computational environment (CE) comprises a result generator configured to generate the result (R) by executing the computational program (CP) using the computational data (CD) within the computational environment (CE) and save the result in a first computer storage (ST₁); a meta-versioning data collection system including a meta-version database (MVD), the meta-versioning data collection system being configured to: create a meta-version label (MVL) including information associated to a current state of the computational system (CS), create copies, on the meta-version database (MVD), of the respective non-persistent elements, and saving, on the meta-version database (MVD), respective first information records indicating respective relationships between the one or more respective non-persistent elements and the meta-version label (MVL), save second information records indicating respective relationships between the one or more respective persistent elements and the meta-version label (MVL) and the address of a storage containing the persistent elements, and save third information records indicating respective relationships between the one or more respective version-controlled elements and the meta-version label (MVL) and the address of a storage containing the version-controlled elements; a deployment module configured to: recreate the current state of the computational system (CS) by transferring from the meta-version database (MVD) and from at least one external storage on the basis of said first, second, and third information records: the copy of the one or more non-persistent elements (EL₁), relationships with the one or more persistent elements (EL₂), and relationships with the version-controlled elements (EL₃); provide a deployed and configured computational environment (VCE), a deployed and configured computational program (VCP) and a deployed and configured computational data (VCD) by using the recreated current state of elements of the computational system (CS); and a verification result generator configured to generate a verification result (VR) by executing the deployed and configured computational program (VCP) using the deployed and configured computational data (VCD) within the deployed and configured computational environment (VCE), and to save the verification result (VR) in a second computer storage (ST₂).

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations. The invention will now be described by way of non-limiting examples, with particular reference to the figures in the accompanying drawings, in which:

FIG. 1 is a block diagram of a system according to an embodiment.

FIG. 2 is a flow diagram of a method according to an embodiment.

### DETAILED DESCRIPTION

Exemplary aspects are described herein in the context of systems and methods for implementing a verification process of a result of execution of a computational system. Those of ordinary skill in the art will realize that the following description is illustrative only and is not intended to be limiting in any way. Other aspects will readily suggest themselves to those skilled in the art having the benefit of the disclosure. Reference will now be made in detail to implementations of the example aspects as illustrated in the accompanying drawings. The same reference indicators will be used to the extent possible throughout the drawings and the following description to refer to the same or like items.

As an introduction, some definitions and concepts that are used in describing aspects of the disclosure are provided below.

Versioning is a process of preserving a current state of objects comprising digital data and metadata stored in different media such as files, databases, different memory segments, custom objects, mobile devices, smart cards, or cryptographic processors. In an embodiment, a versioning operation allows for preservation of a state of a number of objects containing digital data and metadata as they existed at a certain moment in time, in different locations including different versioning systems and storages that do not have built-in versioning mechanisms. The versioning operation is carried out by a meta-versioning tracking system (MVTS).

Data sources are accessed through a database management system or other system to extract data from these sources versus, for example, extracting data directly from a CSV file that sometimes can be managed by a version management system. Furthermore, data sources can be of several types: datasets that never change and datasets that have built-in versioning.

Embodiments can handle one or more of three types of sources: a source that never changes, a source that has a version tracking, either built-in or external, and a source that changes, but does not have a version control, either built-in or external.

In particular, the stable data sources are represented by their identifiers that provide sufficient information to system users to uniquely identify such resources. Built-in version tracking can be implemented in the form of adding a version field to each record in the database or by creating different databases, for example, tables or entire databases, for different versions. The versioned data sources are represented by their identifiers that provide sufficient information to system users to uniquely identify such resource and one of its versions.

Preservation of a state associated with a version has two primary components: creating a copy of a data source as the data source existed at a certain moment in time and storing it separately from the original and obtaining a label of a version of the data source if the data source has a version tracking mechanism. In some cases, creating a copy of the data source is warranted even if the original data is stored in a system with a version tracking mechanism, for example, if there is a need to create a copy of the system that has not been marked with a version for a major release.

A computational system CS is a complex information system that comprises the following three elements: computational program CP, computational data CD and computational environment CE. In particular, the computational program CP comprises software programs, the computational data CD comprises data sources and the computational environments comprises objects such as file or non-file information units.

Each one of these three elements can be stable and never change or have a versioning mechanism assigned to it, either internally or externally.

Programs by their nature are developed for particular types and versions of operating systems. For example, most programs developed for Linux cannot run on a Windows OS, and vice versa. Similarly, most programs developed for 64-bit versions of Windows cannot run on 32-versions of that OS. Due to the differences between different versions of operating systems, a particular computational system may be able to run on one version of the operating system, but be unable to run on another version, or produce a different result (due e.g., to different libraries). Some programs rely on a particular version of the execution environment, for example, versions of Java Development Kit (JDK) or .NET environment. In general, applications developed for different application binary interfaces (ABI) define the low-level binary interface between two or more pieces of software on a particular architecture. ABI defines how an application interacts with itself, how an application interacts with the kernel, and how an application interacts with libraries. An application developed using one ABI may have a problem running on a kernel and using libraries different than the ones defined in the ABI for which it was originally developed.

Fileless objects can run externally using virtual machines or external server clusters such as Google Cloud, Amazon Web Services, IBM Cloud, Oracle Cloud Infrastructure, VMware Cloud, and Microsoft Azure.

Both the operating system and additional elements comprising the execution of the computational system are essential for correct execution of the computational system. The results of execution of a particular computational system using the same computational program and computational data depend on the computational environment comprising the operating system and additional elements enabling the execution of the computational program.

An example of a software program that can be a part of the system and never changes can be a database management system that manipulates with an outdated file format such as Cobol. Different versions of software systems under development can be tracked within version tracking systems maintained by organizations that develop software systems.

An example of objects that can be persistent objects is a website that can be accessed via a predefined URL or a file that can be accessed via a predefined UNC path.

In general, several different ways to deal with the source code saved in a version tracking system that is external to the meta-version tracking system can be utilized. One way is to obtain a complete copy of the external version tracking system including the version of the external source code that is related to the current meta-version. Another way is to only obtain a copy of the version of the external source code that is related to the current meta-version.

According to embodiments, a third way is saving a string of information that uniquely identifies the version of the external source code within the external version tracking system. In an embodiment, such information (e.g. in a string) comprises authentication information and location of that version such that it is sufficient to automatically connect to the external version tracking system and to extract data from that system.

According to an aspect, when a large collection of static data, for example, the result of a large scientific collection effort, was used on a project, there can be different ways of preserving that data for the purpose of creating a meta-version. One way would be to create a replica of that dataset locally to the meta-version tracking system. That would require significant effort to transfer the data and significant cost to re-create hardware and software infrastructure to store the data.

According to an embodiment, another way is to record a string that uniquely identifies the external data set. In an embodiment, that string comprises authentication and location data sufficient to automatically connect to the external dataset.

According to another aspect, an external source has a built-in versioning system. For example, each row in a table within a database can be marked with a version number. One way to preserve the version of such an object would be to copy the entire database with all versions locally to the meta-versioning system. Another way would be to only copy the records marked with the version that is related to the current meta-version of the system.

According to an embodiment, another way is to store a string uniquely identifying all the records within the external system.

According to an embodiment, that string comprises authentication and location information sufficient to automatically connect to the external source and access the corresponding version of the data. In an embodiment, that string comprises a filter or a SQL statement used to identify the version of the data from that source that is corresponding to the current meta-version.

According to an embodiment, a particular version of virtual machines, docker containers, or external server environments is used. A container is a standard unit of software that packages up code and all its dependencies so the application runs quickly and reliably from one computing environment to another. Docker containers and docker versioning systems allow on certain OS creation of snapshot of data modified in containers, as well as snapshots of a given running container (complete set of inside processes).

In an embodiment, the state of the virtual machine is preserved by creating a local copy of the backup of that virtual machine. Using a virtual machine is an example of an element of the computational environment (CE). In an embodiment, the meta-versioning system preserves a link, or a reference, or an address string with connection, login, and configuration parameters sufficient to recreate the virtual machine. In another embodiment, the meta-versioning system preserves a copy of the image of the virtual machine in the versioning system database (MVD).

According to an embodiment of a method, another way is to preserve a string that uniquely identifies the current version of the virtual machine running in a remote environment, for example, in the cloud. According to a further embodiment, that string further comprises authentication and location data sufficient to automatically connect to that virtual machine.

According to a method, another way is to preserve a string that uniquely identifies the backup version of the virtual machine running in a remote environment, for example, in the cloud. In an embodiment, that string further comprises authentication and location data sufficient to automatically access that backup of a virtual machine. In another embodiment, that string further comprises instructions or a script sufficient to instantiate that virtual machine from a backup.

In an embodiment, a system can keep an identity of elements that are comprised in a certain computational system CS, in such a way that each identity provides sufficient information for system users to identify such elements to either start using the element immediately, or to be able to use the element after certain manipulation, for example, after compilation of source code or after starting a virtual machine.

As previously described, the versioning process is carried out in order for different entities, such as groups of scientists, research institutes, universities, R&D laboratories, and corporations, to be able to reliably cooperate with each other.

Generally speaking, a first entity can be defined as a developer party DP. The developer party DP creates the computational system CS in a specific location at a specific moment in time, and by executing the elements of that computational system CS, a corresponding specific result R is obtained.

A second entity can be defined as a verifying party VP. In certain embodiments, the second entity can be the same as the first entity. Accordingly, systems and methods can be used by a group of scientist users as an internal time-saving and cost-effective tool to rapidly deploy a computational system to get the result of computing by different computational programs (various algorithms related to different scientific models) based on the same computational data. Or it can be used to compute using the same algorithms with different sets of data.

The verifying party VP aims to recreate the same result R previously obtained by the developer party DP, in order to work on a consistent environment. Hence, the verifying party VP needs to create a computational system CS whose elements are identical to the elements of the computational system CS used by the developer party DP to originally obtain the result R. The result generator 110, the meta-versioning data collection system 120, the deployment module 130, the verification result generator 140 and the report module 150 are located in the parts of CS used to host appropriate computer resources, could be any of local computers, part of HPC cluster or network-accessible computers in the cloud.

In turn, the verifying party VP that makes any changes to any of the elements of the computational system CS becomes a new developer party DP, since those changes would lead to different execution results.

The versioning process is thus applicable to the new computational system CS, and so on for any computational system that can be further modified by any other developer party DP.

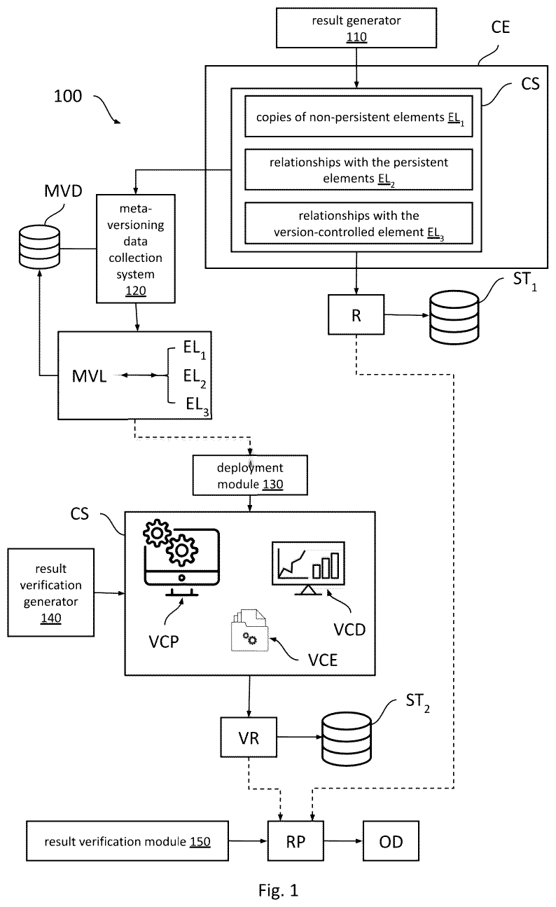

FIG. 1 is a block diagram illustrating an exemplary system 100 for verification of a result R of execution of a computational system CS according to aspects of the present disclosure, wherein dashed lines represent the movement of data, e.g., the result R, and solid lines represent interactions between system elements. System 100 can comprise: a result generator 110, a meta-versioning data collection system 120, a deployment module 130, a verification result generator 140 and a report module 150. Though not depicted, system 100 can be implemented by at least one processor and memory operably coupled to the at least one processor, and instructions to implement the data collection system 120, the deployment module 130, the verification result generator 140, and the report module 150.

According to an embodiment, the result generator 110 is configured to generate the result R by executing the computational program CP using the computational data CD within the computational environment CE and save the result in a computer storage ST1. The relationship between persistent or non-persistent elements, MVL, and storage including version-controlled could be described as references which can comprise unique identifiers, timestamps, addresses, for example, URI/URL/IP address, json data, DB data, or other information capable to uniquely identify parties.

In an embodiment, the system 100 automatically captures and creates a snapshot of the data structures in computer memory used by the computational program while running in a cluster or on a local computer. When re-instantiating the instance retrieved from the storage, for example, from a file storage or a database, the re-instantiated version of the computational program needs to be able to access the same data structures in computer memory. In other words, the relationship between the computational program and the data snapshot is a version of data used by the instance of the program stored within the versioning systems.

In an embodiment, executable (binary) code of a program is generated from the source code (resulting non-persistent element) in the form of compilation of a source code.

The result R is the output of the execution operation done on a large amount of data. This result R can be any type of digital output, for example, a set of instructions such as a script or a collection of bits stored in a computer memory. Instructions are a way to execute a plurality of commands in order to achieve the designated goal. Script is an example of describing a set of instructions in a single place, for example, a bash script, a batch script, or any other computer scripting language written text.

According to an embodiment, the meta-versioning data collection system 100 includes a meta-version database MVD and it is configured to create a meta-version label MVL including information associated with a current state of the computational system CS.

The preservation of the current state of elements of the computational system CS is done by linking information of the elements of the computational system CS to the meta-version label MVL. In this regard, the meta-versioning data collection system 120 performs the following operations:
creating copies, on the meta-version database MVD, of the respective non-persistent elements, and saving, on the meta-version database MVD, respective first information records indicating respective relationships between the one or more respective non-persistent elements and the meta-version label MVL;
saving second information records indicating respective relationships between the one or more respective persistent elements and the meta-version label MVL and the address of a storage containing the persistent elements;
saving third information records indicating respective relationships between the one or more respective version-controlled elements and the meta-version label MVL and the address of a storage containing the version-controlled elements.
   In other words, all information for the given version that is stored in a data structure within the system, is assembled in one record that is marked with the label MVL. Such a record comprising the data structure with all information for the given version with associated elements creates one or more relationships between associated elements during their deployment and execution.

In an embodiment, a copy of the external resource is saved within the system 100, and a string configured to connect to it is stored within the meta-versioning data collection system 120. In an embodiment, a copy of the external resource is saved within or outside of meta-versioning data collection system 120, and a string sufficient to connect to the external resource is stored within the meta-versioning data collection system 120.

In an embodiment, when a record about a source is added to the meta-versioning data collection system 120, an additional data object is also added that contains instructions or a script to bring the source to a working order. In an embodiment, these instructions of the script are executed to bring the source to a working order.

In an embodiment, the meta-versioning data collection system 120 stores homogenous resources, some part of which are internal resources, some part of which are external resources originally stored in a cloud storage, some part of which are generated on demand by a data generation system, using, for example, a generative artificial intelligence system. Resources can be datasets, executable source code, or resources of other types.

In an embodiment, the meta-versioning data collection system 120 is deployed on a portable storage to create a portable meta-versioning data collection system.

In an embodiment, the meta-versioning data collection system 120 is deployed on an external cloud storage to create a cloud-based meta-versioning data collection system.

In an embodiment, the meta-versioning data collection system 120 uses rules to filter resources to be stored by their type. In particular, these rules can be security rules to prevent storing external resources with executable source code.

In an embodiment, the meta-versioning data collection system 120 can be a distributed meta-versioning data collection system, some parts of which, such as a software application running on the computer, can be deployed on a local storage, and other parts of which, such as a web-based application hosted remotely, are deployed on an external storage, for example, a cloud storage, or on a portable storage.

In an embodiment, the meta-versioning data collection system 120 uses adaptive rules to minimize latency of an access to a specific version stored within the meta-versioning data collection system 120.

In an embodiment, the meta-versioning data collection system 120 uses an artificial intelligence module to analyze resources being stored to generate metadata describing those resources. The generated metadata can be used to create reports on resources comprehensive for human users.

In an embodiment, the meta-versioning data collection system 120 uses strings to connect to resources stored within the meta-versioning data collection system 120 to test quality of connection to the stored resources and generate reports on availability of resources. In this embodiment, a string is a textual representation comprising information related to an address, a set of credentials, a parameter, or a resource descriptor, which can be transferred over standard channels for textual information to perform some operations inside data collection system 120, for example, SQL or URI.

In an embodiment, the meta-versioning data collection system 120 uses a data structure that comprises strings of characters to store integrity of the data, for example, a checksum or a cryptographic signature, or to store the data related to the reliability of particular a storage used to store elements, external storages, or network connections, which can be utilized to check availability, comprising information about the current state of the storage, external storage, or networking, or to verify the integrity of stored elements and storage.

In an embodiment, the meta-versioning data collection system 120 uses information about availability of resources to detect resources with low or unstable availability to restore those resources to another storage with sufficient level of availability.

According to an embodiment, the deployment module 130 is configured to create a computational system CS whose elements are identical to the current state of elements of the computational system CS. In this regard, the deployment module 130 is configured to:
recreate the current state of elements of the computational system CS by transferring from the meta-version database MVD and from external storages on the basis of said first, second and third information records:
   the copies of the one or more non-persistent elements EL₁;
   relationships with the one or more persistent elements EL₂; and
   relationships with the version-controlled elements EL₃;
provide a deployed and configured computational environment VCE, a deployed and configured computational program VCP and a deployed and configured computational data VCD by using the recreated current state of elements of the computational system CS.

According to an embodiment, the verification result generator 140 is configured to generate a verification result VR by executing the deployed and configured computational program VCP using the deployed and configured computational data VCD within the deployed and configured computational environment VCE, and to save the verification result VR in a computer storage ST₂.

According to an embodiment, the computer storage ST₁ and the computer storage ST₂ are the same entity.

According to another embodiment, the computer storage ST₁ and the computer storage ST₂ are two different entities.

According to an embodiment, the report module 150 is configured to generate a comparison of the verification result VR to the result R previously generated by the result generator 100, to generate a report RP comprising the comparison, and to send the report RP to an output device OD.

The report RP is used by the verifying party VP to be aware of whether the recreated computational system CS is identical to the computational system CS previously created by the developer party DP.

In an embodiment, the DP and the VP are the same entity that uses the MVTS to store information about the computational system (CS) with variable computational program (CP), or computational data (CD), or computational environment (CE), to recreate a computing scenario and change only one portion of the computational algorithms while keeping the rest of the environment in its original state by replacing at least a part of the computational program (CP) or at least a part of the computational data (CD), or at least a part of the configuration environment (CE) to produce new results, without the need to set up the whole computational system (CS) from scratch. This allows users to bring the system to the working state, while replacing or modifying one of the states of the computational program (CP), computational data (CD) or computational environment (CE), or a new instance (version) of computational program (CP) deployed to the appropriate location within the computational system (CS). In this embodiment, tools or scripts describing the editing process of the stored in the multi-version tracking system (MVTS) states, for example, by copying the CP, CD, or CE and following modification, are used. In an embodiment, these operations are followed by the deployment of the modified version. In an embodiment, the modified version is started after deployment.

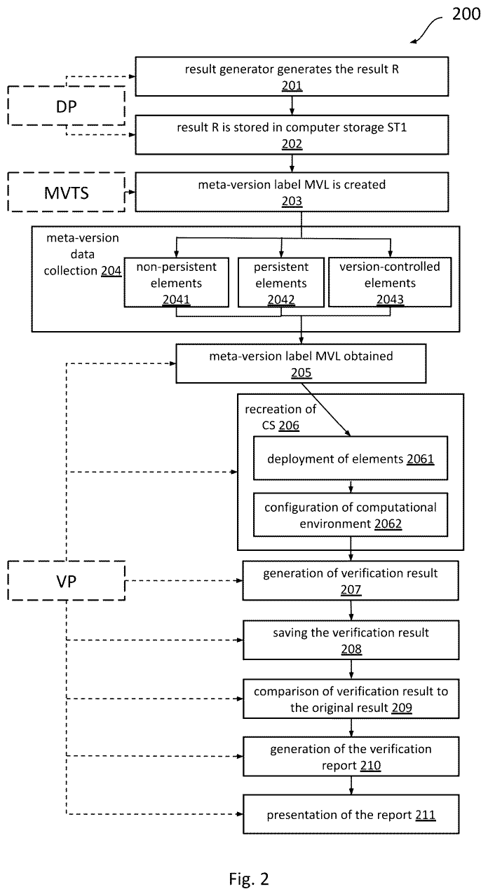

FIG. 2 is a flow diagram of a method 200 of verification of a result R of execution of a computational system CS by a verifying party VP, by preserving a current state of elements of the computational system CS by a developer party DP in a meta-version tracking system MVTS and recreating the current state of elements of the computational system CS by the verifying party VP using saved information at a different location at a different moment in time, the elements of the computational system CS comprising computational program CP, computational data CD, and computational environment CE.

The method of FIG. 2 can be carried out using the system described in conjunction with FIG. 1.

In operation 201, the result generator 110 generates the result R executing the computational program CP using the computational data CD within the computational environment CE of the computational system CS. In other words, the developer party DP by means of the result generator 110 executes the computational program CP using the computational data CD within the computational environment CE of the computational system CS to generate the result.

In operation 202, the method 200 stores the result in a computer storage ST₁.

In operation 203, the meta-version data collection system 120 creates a meta-version label MVL including information associated to a current state of the computational system CS by a meta-version tracking system MVTS including a meta-version database MVD. In other words, the meta-version data collection system 120 creates a meta-version label MVL related to a meta-version of the computational system CS to preserve the current state of the three elements comprised in the computational system, that is the computational program, the computational data and the computational environment.

In operation 204, the meta-version data collection system performs the following sub-operations in any particular order by a meta-version tracking system MVTS:
if one or more elements of the computational systems CS are one or more respective non-persistent elements EL₁, creating and saving 2041 respective copies, on the meta-version database MVD, of the respective non-persistent elements, respective first information records indicating respective relationships between the one or more respective non-persistent elements and the meta-version label MVL;
if one or more elements of the computational systems CS are one or more respective persistent elements EL₂, saving 2042 respective second information records indicating respective relationships between the one or more respective persistent elements and the meta-version label MVL and the address of a storage containing the external persistent elements;
if one or more elements of the computational systems CS are one or more respective version-controlled elements EL₃, saving 2043 respective third information records indicating respective relationships between the one or more respective version-controlled elements and the meta-version label MVL and the address of a storage containing the external version-controlled elements. According to this embodiment, at least one of the elements of the computational systems CS is non-persistent or non-version controlled.

According to an embodiment, the element EL₁, one of the one or more respective non-persistent elements EL₁, one or more respective persistent elements EL₂, and one or more respective non-version-controlled elements EL₃, comprises a computer program.

According to a further embodiment, wherein one of the one or more respective non-persistent elements EL₁, one or more respective persistent element EL₂, and one or more respective non-version-controlled elements EL₃, comprises a database or other data storage.

According to another embodiment, one of the one or more respective non-persistent elements EL₁, one or more respective persistent elements EL₂, and one or more respective non-version-controlled elements EL₃, comprises an execution environment such as a virtual machine or a virtual container.

According to an embodiment, one of the one or more respective non-persistent elements EL₁, one or more respective persistent elements EL₂, and one or more respective non-version-controlled elements EL₃ comprises configuration or deploying information related to the computational system CS.

According to one embodiment, one of the one or more respective non-persistent elements EL₁, one or more respective persistent elements EL₂, and one or more respective non-version-controlled elements EL₃ comprises a compilable source code and wherein sub-operation 2061 is followed by automatic compilation of the compilable source code.

In operation 205, the verifying party VP obtains the meta-version label MVL from the meta-version tracking system MVTS for the version of the computational system CS that needs to be recreated.

In operation 206, the meta-version data collection system 120 recreates the current state of elements of the computational system CS by performing the following sub-operations:

In sub-operation 2061, the meta-version data collection system 120, in any particular order, transferring data from the meta-version database MVD and from external storages, on the basis of said first, second and third information records: the copy of the one or more non-persistent elements EL₁, relationships with the one or more persistent elements EL₂ and relationships with the one or more version-controlled elements EL₃.

In sub-operation 2062, the deployment module 130, in any particular order, provides a deployed and configured computational environment VCE, a deployed and configured computational program VCP and a deployed and configured computational data VCD by using the elements transferred in sub-operation 2061.

In operation 207, the result verification generator 140 generates a verification result VR by executing the deployed and configured computational program VCP using the deployed and configured computational data VCD within the deployed and configured computational environment VCE generated in sub-operation 2062.

In an embodiment, in operation 208, the result verification generator 140 saves the verification result in a computer storage ST₂.

In an embodiment, in operation 209, the result verification module 150 compares the verification result VR to the result R previously generated in operation 201.

In an embodiment, in operation 210, the result verification module 150 generates a report RP comprising the comparison of operation 209.

In an embodiment, in operation 211, the result verification module 150 sends the report RP of operation 210 to an output device OD.

According to an embodiment, one of the one or more respective non-persistent elements EL₁, one or more respective persistent elements EL₂, and one or more respective non-version-controlled elements EL₃ comprises executable source code and wherein sub-operation 2061 is followed by automatic execution of the executable source code code to make a change to computational program (CP), computational data (CD), or a computational environment (CE).

According to one embodiment, one of the one or more respective non-persistent elements EL₁, one or more respective persistent elements EL₂, and one or more respective non-version-controlled elements EL₃ is a database or other data collection, and at least one of the remaining two elements is a computer program configured to use said database or other data collection, wherein the computer program is automatically configured to use said database or other data collection.

In an embodiment, the verification result (VR) generated by the verifying party (VP) is further compared to the result (R) of operation 207.

Advantages of embodiments are to reduce the time required to store or recreate a computational system and to get a result for verification, to reduce storage space needed to preserve a version of a computational system comprising multiple elements, such as executable environments, datasets, files, and other data objects, as well as to decrease the creation time of the modified version of CS by deploying the versions stored in MTVS, and to increase accuracy, consistency, and integrity of the recreated system to ensure adequate comparison of results.

1. A method of verification, by a verifying party (VP), of a result (R) of execution of a computational system (CS), which comprises computational system elements including a computational program (CP) comprising a script or binary code, computational data (CD) comprising structured data records stored on a hard drive as one or more files or any other part of a computer memory and accessible through an interface, and a computational environment (CE) comprising one or more physical or virtual computers, operating systems, libraries, or runtime environments, the method comprising:
A. generating, by a developer party (DP), the result (R) by executing the computational program (CP) using the computational data (CD) within the computational environment (CE);
B. saving, by the developer party (DP), the result (R) in a first computer storage (ST1);
C. creating, by a meta-version tracking system (MVTS) comprising a meta-version database (MVD), a meta-version label (MVL) including information associated to a current state of the computational system (CS) and performing, by the meta-version tracking system (MVTS), the following sub-operations in any order:
C1. when one or more elements of the computational systems (CS) are one or more respective non-persistent elements (EL₁), creating respective copies, on the meta-version database (MVD), of the respective non-persistent elements, and saving, on the meta-version database (MVD), respective first information records indicating respective relationships between the one or more respective non-persistent elements (EL₁) and the meta-version label (MVL),
C2. when one or more elements of the computational systems (CS) are one or more respective persistent elements (EL₂), saving respective second information records indicating respective relationships between the one or more respective persistent elements (EL₂) and the meta-version label (MVL) and an address and authentication information of a storage containing the one or more respective persistent elements (EL₂),
C3. when one or more elements of the computational systems (CS) are one or more respective version-controlled elements (EL₃), saving in the meta-version database (MVD) respective third information records indicating respective relationships between the one or more respective version-controlled elements (EL₃) and the meta-version label (MVL) and an address and authentication information of a storage containing the one or more respective version-controlled elements (EL₃),
wherein at least one of the elements of the computational systems (CS) is non-persistent or non-version controlled;
D. obtaining, by the verifying party (VP) from the meta-version tracking system (MVTS), the meta-version label (MVL);
E. recreating, by the verifying party (VP), the current state of the computational system (CS) by performing the following sub-operations:
E1. in any order, transferring from the meta-version database (MVD) and from at least one external storage, on the basis of said first, second, and third information records:
the copy of the one or more non-persistent elements (EL1),
relationships with the one or more persistent elements (EL2), and
relationships with the one or more version-controlled elements (EL3),
E2. providing a deployed and configured computational environment (VCE), a deployed and configured computational program (VCP) and a deployed and configured computational data (VCD) by using the elements transferred in sub-operation E1;
F. generating, by the verifying party (VP), a verification result (VR) by executing the deployed and configured computational program (VCP) using the deployed and configured computational data (VCD) within the deployed and configured computational environment (VCE) provided in sub-operation E2; and
G. saving, by the verifying party (VP), the verification result (VR) in a second computer storage (ST₂).

2. The method of claim 1, wherein one of the one or more respective non-persistent elements (EL₁), the one or more respective persistent elements (EL₂), and the one or more respective non-version-controlled elements (EL₃), comprises a computer program.

3. The method of claim 1, wherein one of the one or more respective non-persistent elements (EL₁), the one or more respective persistent elements (EL₂), and the one or more respective non-version-controlled elements (EL₃), comprises a database or other data storage.

4. The method of claim 1, wherein one of the one or more respective non-persistent elements (EL₁), the one or more respective persistent elements (EL₂), and the one or more respective non-version-controlled elements (EL₃), comprises a virtual machine or a virtual container.

5. The method of claim 1, wherein one of the one or more respective non-persistent elements (EL₁), the one or more respective persistent elements (EL₂), and the one or more respective non-version-controlled elements (EL₃) comprises configuration or deploying information related to the computational system (CS).

6. The method of claim 1, wherein one of the one or more respective non-persistent elements (EL₁), the one or more respective persistent elements (EL₂), and the one or more respective non-version-controlled elements (EL₃) comprises a compilable source code and wherein sub-operation E1 is followed by automatic compilation of the compilable source code.

7. The method of claim 1, wherein one of the one or more respective non-persistent elements (EL₁), one or more respective persistent elements (EL₂), and one or more respective non-version-controlled elements (EL₃) comprises executable source code and wherein sub-operation E1 is followed by automatic execution of the executable source code to make a change to computational program (CP), computational data (CD), or a computational environment (CE).

8. The method of claim 1, one of the one or more respective non-persistent elements (EL₁), the one or more respective persistent elements (EL₂), and the one or more respective non-version-controlled elements (EL₃) is a database or other data collection, and at least one of the remaining two elements is a computer program configured to use said database or other data collection, wherein the computer program is automatically configured to use said database or other data collection.

9. The method of claim 1, further comprising comparing, by the verifying party (VP), the verification result (VR) to the result (R) of operation A.

10. The method of claim 9, further comprising generating, by the verifying party (VP), a report (RP) comprising the comparing, by the verifying party (VP), the verification result (VR) to the result (R).

11. The method of claim 10, further comprising sending, by the verifying party (VP), the report (RP) to an output device (OD).

12. A system for verification of a result (R) of execution of a computational system (CS) comprising elements of the computational system (CS) which include a computational program (CP), computational data (CD) and a computational environment (CE), the system comprising:
a result generator configured to generate the result (R) by executing the computational program (CP) using the computational data (CD) within the computational environment (CE) and save the result in a first computer storage (ST1);
a meta-versioning data collection system including a meta-version database (MVD), the meta-versioning data collection system being configured to:
create a meta-version label (MVL) including information associated to a current state of the computational system (CS),
create copies, on the meta-version database (MVD), of the respective non-persistent elements, and saving, on the meta-version database (MVD), respective first information records indicating respective relationships between the one or more respective non-persistent elements and the meta-version label (MVL),
save second information records indicating respective relationships between the one or more respective persistent elements and the meta-version label (MVL) and the address of a storage containing the persistent elements, and
save third information records indicating respective relationships between the one or more respective version-controlled elements and the meta-version label (MVL) and the address of a storage containing the version-controlled elements;
a deployment module configured to:
recreate the current state of the computational system (CS) by transferring from the meta-version database (MVD) and from at least one external storage on the basis of said first, second, and third information records:
the copy of the one or more non-persistent elements (EL₁),
relationships with the one or more persistent elements (EL₂), and
relationships with the version-controlled elements (EL₃);
provide a deployed and configured computational environment (VCE), a deployed and configured computational program (VCP) and a deployed and configured computational data (VCD) by using the recreated current state of elements of the computational system (CS); and
a verification result generator configured to generate a verification result (VR) by executing the deployed and configured computational program (VCP) using the deployed and configured computational data (VCD) within the deployed and configured computational environment (VCE), and to save the verification result (VR) in a second computer storage (ST2).

13. The system of claim 12, further comprising a report module configured to generate a comparison of the verification result (VR) to the result (R) previously generated by the result generator.

14. The system of claim 13, wherein the report module is further configured to generate a report (RP) comprising said comparison.

15. The system of claim 14, wherein the report module is further configured to send the report (RP) to an output device (OD).

16. The system of claim 12, wherein one of the one or more respective non-persistent elements (EL1), the one or more respective persistent elements (EL2), and the one or more respective non-version-controlled elements (EL3), comprises a computer program.

17. The system of claim 12, wherein one of the one or more respective non-persistent elements (EL1), the one or more respective persistent elements (EL2), and the one or more respective non-version-controlled elements (EL3), comprises a database or other data storage.

18. The system of claim 12, wherein one of the one or more respective non-persistent elements (EL1), the one or more respective persistent elements (EL2), and the one or more respective non-version-controlled elements (EL3), comprises an execution environment such as a virtual machine or a virtual container.

19. The system of claim 12, wherein one of the one or more respective non-persistent elements (EL1), the one or more respective persistent elements (EL2), and the one or more respective non-version-controlled elements (EL3) comprises configuration or deploying information related to the computational system (CS).

20. The system of claim 12, wherein one of the one or more respective non-persistent elements (EL1), the one or more respective persistent elements (EL2), and the one or more respective non-version-controlled elements (EL3) comprises a compilable source code and wherein transferring from the meta-version database (MVD) and from the at least one external storage is followed by automatic compilation of the compilable source code.
